(19) United States
(12) Patent Application Publication
(10) Pub. No.: US 2004/0113395 A1
(43) Pub. Date: Jun. 17, 2004

(54) Trolley for luggage or other loads

(76) Inventor: Giuseppe Nimis, Mesagne (IT)

Correspondence Address: MUSERLIAN AND LUCAS AND MERCANTI, LLP, 475 PARK AVENUE SOUTH, NEW YORK, NY, 10016, US

(21) Appl. No.: 10/475,416

(22) PCT Filed: Apr. 23, 2002
(86) PCT No.: PCT/IT02/00260

(30) Foreign Application Priority Data
Apr. 23, 2001 (IT) LE01U000004

(51) Int. Cl. B62M 1/00; B62B 1/00

(52) U.S. Cl. 280/651

(57) ABSTRACT

Trolley for luggage and other loads, which comprises a horizontal support (1) connected to a vertical support (2), a handle (4) and at least one front wheel (5, 5′; 10), wherein said horizontal support (1) comprises or is connected to a footboard (6) provided with one or more rear wheels (8, 8′), while said front wheel (10) is steering and is connected to the handle (4) for guiding the trolley.

The present invention relates to a trolley for luggage or other loads, and in particular to a trolley which can be used for easily moving not only these loads, but also the same persons which carry out the motion.

Known trolleys comprise a horizontal support connected to a vertical support, a handle and at least one front wheel for pulling or pushing the trolley. The latter can also be integrated into a suitcase or another container, for example into a trunk or a bag. These known trolleys are often disadvantageously difficult to be pushed or pulled, especially when the load is heavy and the wheels are small for reducing the overall dimensions.

It is therefore an object of the present invention to provide a trolley which is free from said disadvantages. Said object is achieved with a trolley, the main features of which are disclosed in the first claim and other features are disclosed in the subsequent claims.

Thanks to the footboard, the rear wheels and the steering wheel which is provided with, the trolley according to the present invention can be set in motion by the user, so as to obtain an effort reduction in the transport and a simultaneous higher motion speed, not only of the load, but also of the user himself.

According to a particular advantageous aspect of the invention, the footboard can be folded or slid under or over the horizontal support, so as to reduce the trolley dimensions when it is not used.

According to another particular advantageous aspect of the invention, the handle, when acts as a handlebar, can be arranged in a position comfortable for the user thanks to an extensible bar and/or a joint.

According to a further particular advantageous aspect of the invention, the trolley can be provided with one or more auxiliary wheels, preferably pivoting, for improving the stability and the solidity of the trolley when used.

Finally, the trolley according to the present invention can be easily integrated into a suitcase or another container without significantly increasing the dimensions when the trolley is not used.

Further advantages and features of the trolley according to the present invention will be clear to those skilled in the art from the following detailed and non-limiting description of some embodiments thereof with reference to the attached drawings, wherein:

FIG. 1 shows a front view of the trolley according to a first embodiment, in a closed position;

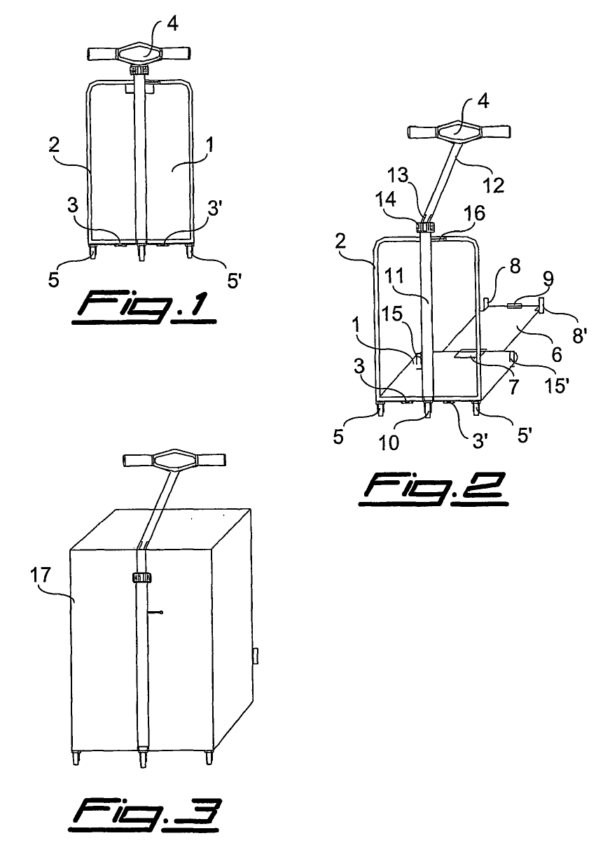

FIG. 2 shows a perspective view of the trolley of FIG. 1, in an open position;

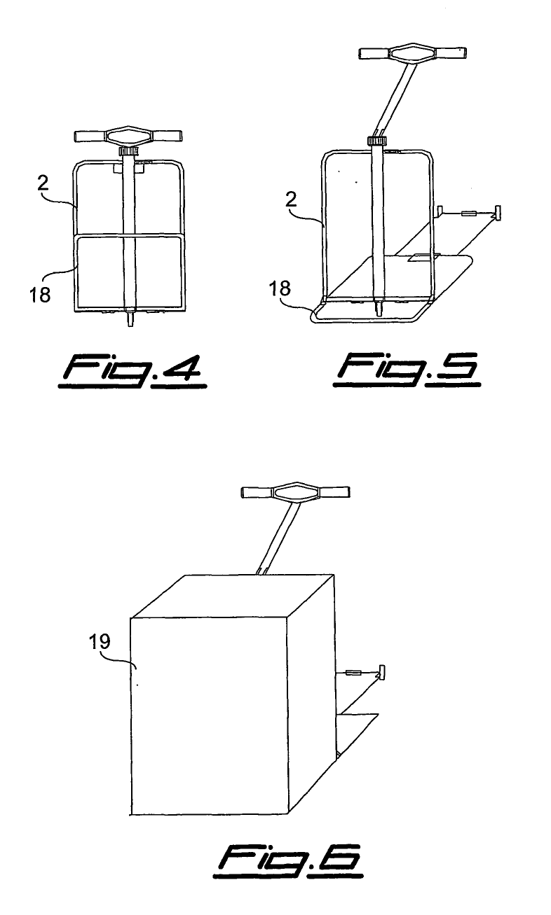

FIG. 3 shows a perspective view of a container comprising the trolley according to a second embodiment similar to the first one;

FIG. 4 shows a front view of the trolley according to a third embodiment, in a closed position;

FIG. 5 shows a perspective view of the trolley of FIG. 4, in an open position; and

FIG. 6 shows a perspective view of a container comprising the trolley according to a fourth embodiment similar to the third one.

Referring to FIG. 1, it is seen that the trolley according to the first embodiment of the present invention comprises in a known way a horizontal support 1, consisting for example in a metal plate, on which the loads to be carried can be laid. The horizontal support 1 is connected to a vertical support 2, consisting for example in a metallic tubular fame, preferably by means of one or more hinges 3, 3′. The trolley is further provided in a known way with a handle 4 and with one or more front wheels 5, 5′ for being hand-pulled by the user.

In FIG. 1 the trolley is closed and locked, i.e. with the horizontal support 1 folded onto the vertical support 2, so that is occupies a limited space and can be easily carried by hand, in a bag or on a shoulder, with a suitable strap (not shown in the figure).

Referring to FIG. 2, it is seen that the trolley according to the present embodiment of the invention suitably comprises a footboard 6 connected to the horizontal support 1, preferably by means of a hinge 7 or other mechanisms. Footboard 6 can be a plate hinged to the horizontal support 1, as in the present embodiment, or can also consist in a prolongation or extension of the horizontal support itself. In other embodiments of the invention, footboard 6 can be provided with sliding mechanisms for sliding under or over the horizontal support 1, instead of being hinged to the latter. For supporting the user's weight, footboard 6 is suitably provided with one or more rear wheels 8, 8′. Footboard 6 can also be provided with a pedal 9, which, if pressed by a user's foot, acts onto the rear wheels and/or their shaft, thus acting as a brake for slowing down or stopping the trolley.

The trolley is suitably provided with at least one steering wheel 10 connected to handle 4, which also acts as a handlebar for steeling wheel 10, so as to guide the trolley itself. The steering wheel 10, in particular its fork, is connected to handle 4 by means of a shaft which is arranged in at least one hub 11 fixed to the vertical support 2. The shaft is preferably provided with a bar 12, foldable or telescopic, which can be extended and/or inclined with respect to the shaft thanks to a joint 13, so as to bring handle 4 close to the user for a better control of the trolley. The extensible bar 12 is also provided with a lock 14, for instance threaded, for locking its extension in the desired position. For further improving the trolley stability, one or more wheels 15, 15′ (shown with broken lines), preferably pivoting, can be arranged under the horizontal support 1. Also wheels 5, 5′, if present, are preferably pivoting, so as to follow the direction imparted to the trolley by the steering wheel 10. For locking the shaft rotation when the trolley is pulled, hub 11 can be provided with a key 16, for instance threaded.

The load or the loads to be carried can be locked between the horizontal support 1 and the vertical support 2 by means of straps or elastic bands (not visible in the figure), for avoiding their fall and not compromising the trolley balance.

FIG. 3 shows the trolley according to the second embodiment of the invention, similar to the first one, which is however provided with a container 17, the lower and front surfaces of which made up or include the horizontal support 1 and the vertical support 2, respectively.

Referring to FIGS. 4 and 5, it is seen that the trolley according to the third embodiment of the invention comprises also a front rack 18, preferably hinged to the vertical support 2.

FIG. 6 finally shows the trolley according to the fourth embodiment of the invention, similar to the third one, which is however provided with a container 19, the lower and rear surfaces of which made up or include the front rack 18 and the vertical support 2, respectively.

During the use, for employing the trolley according to the present invention, the user can:

extend the horizontal support 1 and/or footboard 6;

arrange the loads onto the horizontal support 1 and/or onto the front rack 18;

adjust the extension of the extensible bar 12 by means of lock 14;

adjust the inclination of the extensible bar 12 by means of joint 13;

seize handle 4 with both hands;

put a foot onto footboard 6;

push the trolley with the free foot, braking it with pedal 9, if necessary.

Further modifications and/or additions may be made by those skilled in the art to the embodiments of the invention hereinabove described and illustrated, remaining within the scope of the same invention.

1. Trolley for luggage and other loads, which comprises a horizontal support (1) connected to a vertical support (2), a handle (4) and at least one front wheel (5, 5′; 10), characterized in that said horizontal support (1) comprises or is connected to a footboard (6) provided with one or more rear wheels (8, 8′), and that said front wheel (10) is steering and is connected to the handle (4) for guiding the trolley

2. Trolley according to claim 1, characterized in that the horizontal support (1) is connected to the vertical support (2) by means of one or more hinges (3, 3′).

3. Trolley according to one of the previous claims, characterized in that the footboard (6) is connected to the horizontal support (1) by means of a hinge (7).

4. Trolley according to claim 1 or 2, characterized in that the footboard (6) is connected to the horizontal support (1) by means of a sliding mechanism for sliding under or over the horizontal support (1).

5. Trolley according to one of the previous claims, characterized in that the footboard (6) is provided with a pedal (9) acting as a brake.

6. Trolley according to one of the previous claims, characterized in that the steering wheel (10) is connected to the handle (4) by means of a shaft which is arranged in at least one hub (11) fixed to the vertical support (2).

7. Trolley according to claim 6, characterized in that said shaft is provided with a bar (12) which can be extended with respect to the shaft.

8. Trolley according to claim 7, characterized in that said extensible bar (12) is provided with a lock (14) for locking its extension in the desired position.

9. Trolley according to claim 7 or 8, characterized in that said extensible bar (12) can be inclined with respect to the shaft by means of a joint (13).

10. Trolley according to one of claims 6 to 9, characterized in that the hub (11) is provided with a key (16) for locking the shaft rotation.

11. Trolley according to one of the previous claims, characterized in that one or more wheels (15, 15′), preferably pivoting, are arranged under the horizontal support (1).

12. Trolley according to one of the previous claims, characterized in that it comprises one or more pivoting front wheels (5, 5′).

13. Trolley according to one of the previous claims, characterized in that it comprises a container (17), the lower and front surfaces of which made up or include the horizontal support (1) and the vertical support (2), respectively.

14. Trolley according to one of the previous claims, characterized in that it comprises a front rack (18), preferably hinged to the vertical support (2).

15. Trolley according to claim 14, characterized in that it comprises a container (19), the lower and rear surfaces of which made up or include the front rack (18) and the vertical support (2), respectively.
